(19) United States
(12) Patent Application Publication
(10) Pub. No.: US 2008/0068383 A1
(43) Pub. Date: Mar. 20, 2008

(54) RENDERING AND ENCODING GLYPHS

(75) Inventor: Terence S. Dowling, San Jose, CA (US)

Correspondence Address: FISH & RICHARDSON P.C., P.O. Box 1022, MINNEAPOLIS, MN, 55440-1022, US

(73) Assignee: ADOBE SYSTEMS INCORPORATED, San Jose, CA (US)

(21) Appl. No.: 11/563,596

(22) Filed: Nov. 27, 2006

Related U.S. Application Data
(60) Provisional application No. 60/826,372, filed on Sep. 20, 2006.

(51) Int. Cl. G06T 11/20

(52) U.S. Cl. 345/441; 345/468

(57) ABSTRACT

Methods, systems, and apparatus, including computer program products for compactly encoding font information. In one aspect a method is provided that includes identifying a library of elements where each element in the library of elements is associated with an outline and one or more parameters. A glyph is identified that has one or more references to a respective element in the library of elements. Each reference specifies a value for one or more of the parameters associated with the respective element. The glyph is rendered based on each respective element referenced by the glyph. The value of the one or more parameters specified by each reference affects the appearance of the rendered element

### CROSS-REFERENCE TO RELATED APPLICATIONS

This application claims priority to U.S. Provisional Application No. 60/826,372, Rendering and Encoding Glyphs, to Terence Dowling, which was filed on Sep. 20, 2006; the disclosure of the prior application is considered part of (and is incorporated by reference in) the disclosure of this application.

### BACKGROUND

The present disclosure relates to information encoding and, more particularly, to a compact representation of fonts.

A font describes a family of glyphs, typically having a particular style or typeface. Each individual glyph in the font generally represents an individual character in a language and the font can potentially include glyphs for many languages. Each glyph describes how a character should look. A computer font is the digital encoding of a font, typically contained in a file, which is normally used for specifying how characters are to be rendered on a display device, printed by a printer, or both.

An outline font is a computer font wherein each glyph is typically specified as a series of points that describe an outline. For example, FIG. 1A illustrates a glyph 100 represented as a series of lines (e.g., line 110) and curves (e.g. curve 120), such as might be specified in an outline font. Each line or curve in the glyph 100 includes at least one point 130 that specifies the horizontal and vertical position of the end of each line or curve. A rendering 195 of the glyph 100 is illustrated in FIG. 1B.

Each glyph can consist of a number of non-contiguous components. For example, the glyph 100 includes the components 140, 150 and 160 each of which are separate from each other. The outline of each component is typically described by one or more contours that are specified as a series of lines and curves. For example, the font component 150 includes three contours 155A, B and C. Fonts that support characters from many languages, particularly Asian languages, may encode thousands if not tens of thousands of glyphs and the glyphs' constituent component outlines.

### SUMMARY

In general, one aspect of the subject matter described in this specification can be embodied in methods that include the actions of identifying a library of elements where each element in the library of elements is associated with an outline and one or more parameters. A glyph is identified that has one or more references to a respective element in the library of elements. Each reference specifies a value for one or more of the parameters associated with the respective element. The glyph is rendered based on each respective element referenced by the glyph. The value of the one or more parameters specified by each reference affects the appearance of the rendered element. Other embodiments of this aspect include corresponding systems, apparatus, and computer program products.

These and other embodiments can optionally include one or more of the following features. Each element in the library of elements can be distinct from all other elements in the library of elements. Rendering the glyph can include rendering each outline associated with each respective element referenced by the glyph based on the value of the associated one or more parameters, where the value of each of one or more parameters affect the shape of the outline. Each of the one or more parameters associated with an element can describe transformations of the associated outline, where each transformation affects the shape of the outline when rendered. The transformations can affect one or more of the outline's height, width, rotation, thickness, taper, extension, radius, and curvature. Each transformation can affect the shape of a portion of the outline.

In general, another aspect of the subject matter described in this specification can be embodied in methods that include the actions of encoding a library of elements, where each element in the library of elements is associated with an outline and with one or more parameters. Each element in the library of elements is distinct from all other elements in the library. A glyph is encoded based on a plurality of references to respective elements in the library of elements. Each reference includes a value for one or more of the associated one or more parameters. Other embodiments of this aspect include corresponding systems, apparatus, and computer program products.

These and other embodiments can optionally include one or more of the following features. Each of one or more parameters can be associated to a transformation of the element's associated outline. Transformations can affect the shape of the outline and can include one or more of the following: height, width, rotation, thickness, taper, extension, radius, and curvature. Each transformation can affect the shape of a portion of the outline. The value of parameters in the reference can be encoded using offsets relative to the value of a previously encoded reference. The smallest absolute value of each parameter can be determined. Encoding the glyph can include encoding a plurality of references that refer to a particular element by specifying values for the parameters of the particular element for each of the plurality of references and identifying the particular element only once. Encoding the glyph can include encoding values using variable byte encoding.

In general, one aspect of the subject matter described in this specification can be embodied in a computer readable media including a data structure for storing a glyph. The data structure includes one or more references to an element in a library of elements, where each element in the library of elements is associated with an outline. The data structure also includes a plurality of values for each of the one or more references, the one or more values specifying the shape of the outline associated with the respective element of the one or more references.

Particular embodiments of the subject matter described in this specification can be implemented to realize one or more of the following advantages. A font can be specified and encoded in a manner that requires very little storage space compared to specifying an outline for each glyph component. A glyph can be specified and encoded based on a combination of outline elements rather than as one or more contours. Designing the glyphs of a font using a combination of outline elements can reduce the design effort. Reusing elements in glyphs improves intra-glyph and inter-glyph consistency, which is important to both readability and quality. The numerical value of parameters, which affect the precise shape of outline elements in the glyph, can be stacked to reduce the size of the glyph encoding. Numerical values in the glyph can be variable byte encoded or specified as relative offsets to further reduce the size of the encoded glyph.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1A is an illustration of a glyph as specified in an outline font.

FIG. 1B is an illustration of a rendering of the glyph illustrated in FIG. 1A.

FIG. 2A is an illustration of a glyph whose components includes several outlines associated to various elements.

FIG. 2B is an illustration of a rendering of the glyph illustrated in FIG. 2A.

FIG. 3 is an illustration of a font including several of the font's glyphs referring to elements in a library of elements.

FIG. 4 illustrates how the value of parameters associated with elements referenced in a glyph can affect the appearance of outlines in the glyph.

FIG. 5 is a flow diagram for rendering a glyph that includes references to the elements in a library of elements.

FIG. 6 is a block diagram of a system for rendering glyphs that refers to elements from a library of elements.

Like reference numbers and designations in the various drawings indicate like elements.

### DETAILED DESCRIPTION

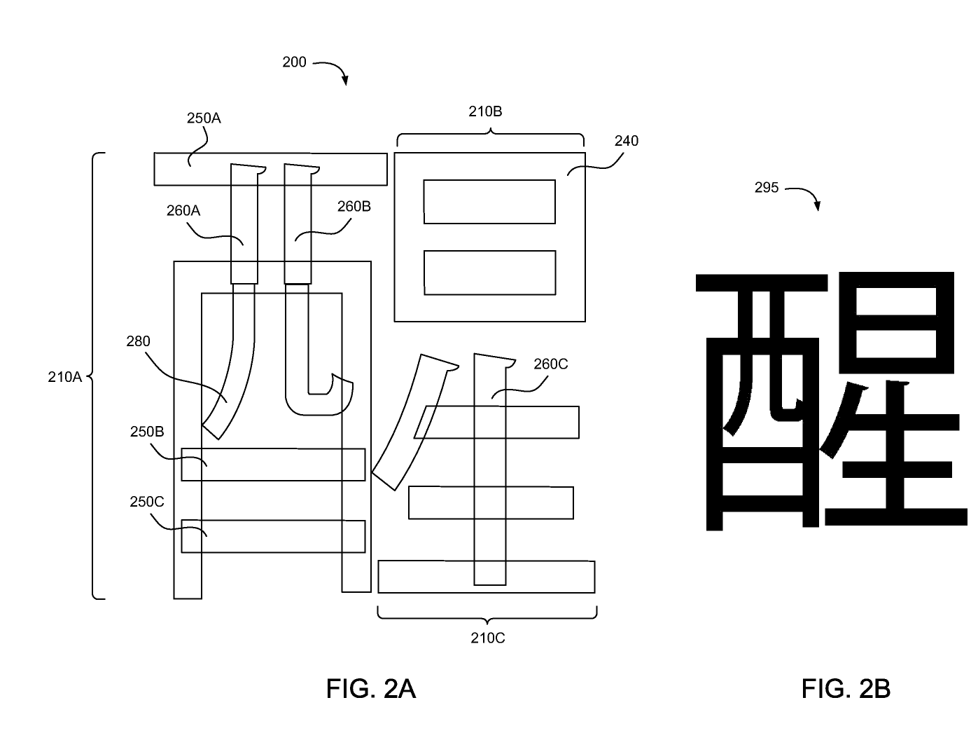

FIG. 2A is an illustration of a glyph 200 whose components 210A-C include several outlines (e.g., outline 250A-C) that are each associated with a respective element (e.g., element 250-260). Each outline is unconnected from other outlines in the glyph. For example, the outline 250A is separate from all other outlines (e.g., outline 260A-C) in the glyph. Each outline associated with an element is an outline specified by one or more contours, which are each specified by a series of lines and curves (e.g., quadratic or cubic Bezier curves).

A rendered glyph can include the outline associated with a particular element multiple times. For example, the outline 250B and the outline 250C have a similar appearance; the outlines only differ in their relative vertical position. The glyph can be said to refer to the same element multiple times. Outline 250A and 250B are also similar; however, in addition to having a different position, these outlines also differ in their relative horizontal size.

Each element is associated with an outline and one or more parameters that specify the appearance of the outline such as the outline's length and width and the outline's vertical and horizontal position. When an element is referenced by a glyph, the rendered glyph includes the outline associated with the referenced element. Each element reference includes values for each of the element's parameters that determine the appearance of the outline in the glyph. Hence, the value of each of an element's parameter is glyph-specific. In some implementations, the glyph need not specify values for each of the glyph's parameters if the parameters are associated with a default value.

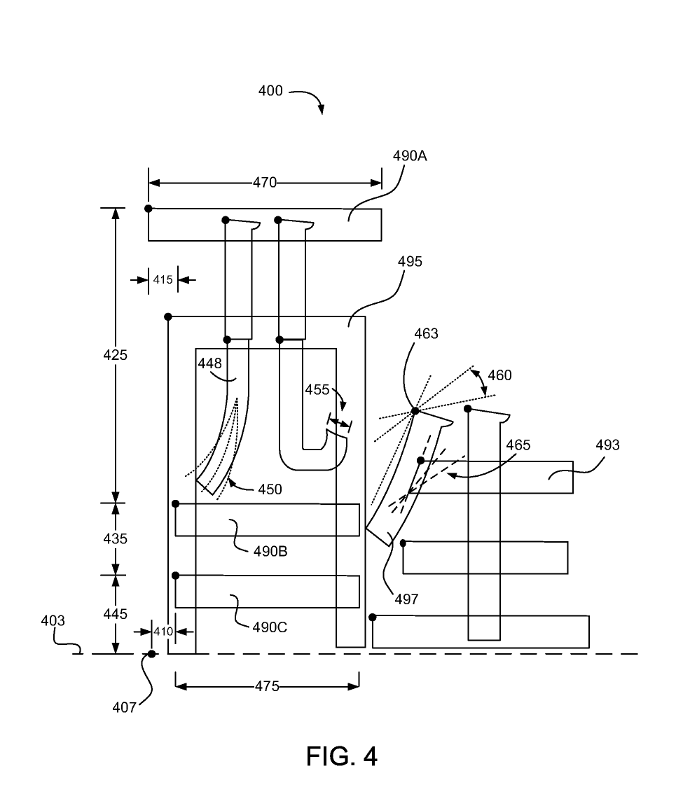

In some implementations, some parameters may not apply to all elements. For example, the element 280 can include a parameter that indicates the thickness of the element and another parameter that specifies the curvature of the element. Although the former parameter is also applicable to the element 250A, the latter parameter is not. Parameters and their potential affect on the appearance of an element's outline are described in further detail in reference to FIG. 4.

A glyph can be specified by referring to one or more pre-defined elements and the specified value of each element's parameters. For example, specifying the glyph 200 can include referring to the element 260 in three separate instances. Each reference includes values for the element's parameters, where the values describe the position and shape of the element's outline in the glyph.

In general, a glyph can also include an outline that is not associated with an element. For example, the outline 240 may not be an element and has no associated parameters, this outline can be specified in the glyph as a series of line segments rather than as a reference to a shape. In some implementations, for a particular font, each element can be identified from a library of elements.

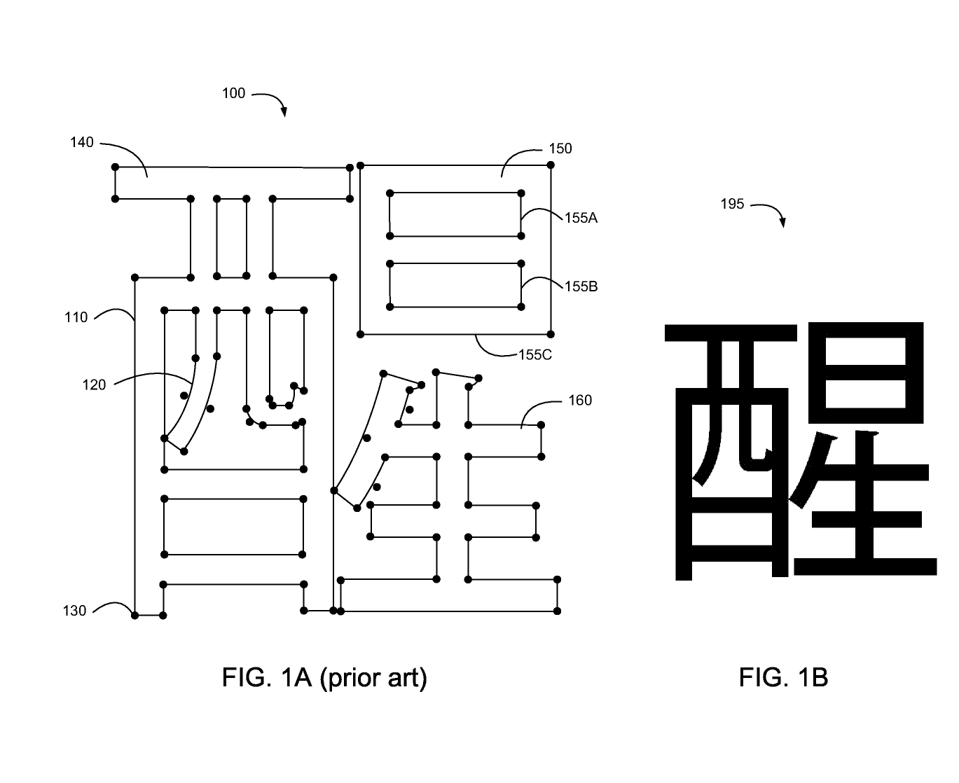

FIG. 2B illustrates a rendering 295 of the glyph 200 illustrated in FIG. 2A. Each outline in the specified glyph is rendered as a solid region rendering a glyph that appears to include only the three separate glyph components. Although, for example, the component 210C in the glyph 200 includes several outlines, the rendered outlines ideally appear identical to a rendering of the corresponding component (e.g., component 160) specified using only a single outline (e.g., compared to the rendering 195 in FIG. 1B). In general, rendering the glyph can include rendering the glyph in color or shades of color, applying visual effects such as drop shadows, outlines, three-dimensional extrusions, rasterizing the glyph into an image, or for use as an image mask. In some implementations, outlines similar to the ones shown in FIG. 1A can be derived from the outline elements shown in FIG. 2A.

The information necessary to specify the glyph 200 can be compared with the information necessary to specify the glyph 100. In particular, note that the component 140 requires at least 48 points to specify each line and curve where each point consists of two values (e.g., horizontal and vertical position). The glyph may, in fact, include far more than 45 points. In contrast, each of the eight element references in component 210A require eight points to specify the position of each outline and as few as eight additional values for each element's parameters. Thus, much more information is necessary to specify the points that define the outline 140 (e.g., 90 values) compared to the information necessary to identify and provide values for the parameters of each of the eight elements (e.g., 24 values) that constitute the largest component of the glyph 200.

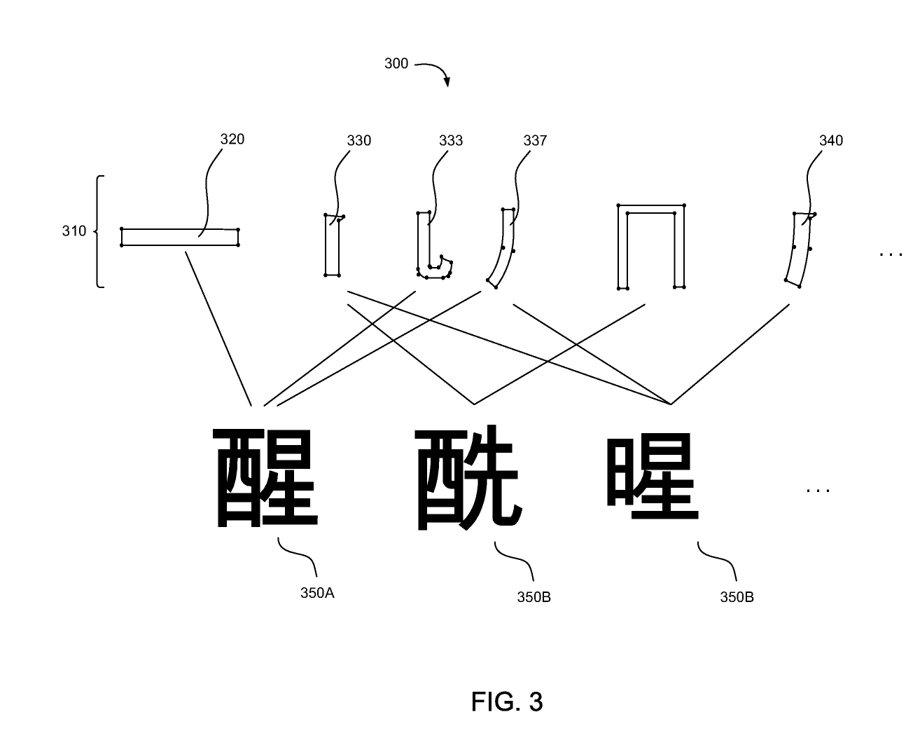

FIG. 3 is an illustration of a font 300 including several of the font's glyphs 350A-C which refer to elements in a library of elements 310. The library of elements 310 includes several elements, each illustrated by their distinct outline (e.g., outline 320, 330 and 340). In general, the outline of each element (e.g., outline 320, 330 and 340) is distinct from the outline of all other elements, such that no two outlines in the library have the same appearance (or could have the same appearance as the result of being transformed according to the parameters of either respective element). For example, in some implementations, the outline 330 and outline 340 appear similar, however the sides of the outline 330 are lines while the sides of outline 340 are curves. In other implementations, the outline 330 and 340 can both be the same, however the parameters of each outline's associated element may differ. For example, the element associated with outline 340 can include a parameter affecting the curvature of the outline, while the element associated with the outline 330 has no such parameter. In such implementations, a glyph requiring the curved variant of the outline 340 refers to the outline's corresponding element and the appropriate curvature parameter, while a glyph constructed from the straight outline 330 refers to the corresponding element without having to include any additional values for the one or more parameters related to the curvature of the outline.

One or more elements in the library can be referred to by each of the glyphs in the font. For example, the glyph 350A may refer to elements 320, 330, 333, 337 and 340. Another glyph 350B may refer to elements 320, 333 and 337. By referring to the elements in the library, each glyph in the font can be specified using less information than would be required if the glyph were specified using only lines and curves. Each element may be referred to repeatedly by glyphs throughout the font, particularly among fonts that include a large number of glyphs that exhibit visual similarity (e.g., fonts that contain Japanese kanji and the characters used in traditional and simplified Chinese script).

FIG. 4 illustrates how the value of parameters (e.g., value 410, 415, 425, 435, 445, 450, 455, 460, 465, and 470) that are associated with the elements referenced in a glyph 400 can affect the appearance of outlines 448, 490A-C, 493, and 497 in the glyph. Each element is associated with several parameters that affect how the outline associated with the element will appear within the glyph. Every element is associated with two positional parameters that specify the respective horizontal and vertical positions of the outline within the glyph. For example, the position of the outline 490C can be specified as an x and y coordinate (e.g., value 410 and value 445, respectively) that is relative to a previously specified point or to an origin 407 that can exist in the glyph (e.g., the left most point on the baseline 403 of the glyph). Every element is also associated with at least one transformational parameter that affects the shape, rather than the position, of the element's outline in the glyph (e.g., the width, height or curvature of the outline).

In general, an element's parameters each correspond to one of a variety of transformations that can be applied to the element's associated outline. Each transformation specifies a manner in which the appearance of the element's outline can be altered (e.g., scaling, rotation or curvature). The value of a parameter affects to what degree the transformation effects the element's outline. For example, the element 490 includes a parameter that is associated with a transformation used to horizontally scale the element's associated outline. Note that the value 470 specifying horizontal scale of the element 490 describes an outline 490A that is larger than when the same element is specified with a value 475, which specifies the horizontal scale of the outline 490C. In this way, the outline of each element can be customized each time the element is referenced by a glyph.

Other transformations can be used to determine an outline's rotation about a point. For example, the element 497 is associated with a parameter whose value 460 affects the rotation of the element's outline around the point 463. The point 463, about which the rotation occurs, can be predetermined for all elements, or can be predetermined for each element. In some implementations, the value of a parameter can be used to affect the nature of a transformation associated with another parameter. For example, the element 497 can be associated with a second parameter that specifies the location of the point about which the rotation of the element's outline occurs (e.g., the point 463).

Elements include each of the following positional parameters which affect the position of the element's outline within the glyph:
Horizontal position, which affects the horizontal position of an element's outline (e.g., value 410) within the glyph.
Vertical position, which affects the vertical position of an element's outline (e.g., value 445) within the glyph.

Particular transformations associated with each element can include one or more of the following transformations:
Horizontal scale, which affects the width of an element's outline (e.g., value 470).
Vertical scale, which affects the height of an element's outline.
Thickness, which affects the thickness (e.g., value 455) of an element's outline without affecting its width. In some implementations, an element can be associated with several thickness parameters each affecting the thickness of different segments of the element's outline. For example, three thickness parameters can affect the relative thickness of each of the one horizontal and two vertical bars of element 495.
Rotation, which affects the outline's (e.g., value 460) rotation about a point.
Curvature, which affects a point of curvature applicable to the outline. For example, the value of a parameter 450 identifies the extent to which the outline 448 curves in a particular direction.
Stroke taper, which affects the extent to which a line or curve in the outline is distorted or tapered with respect to the rest of the outline. For example, the value of parameter 465 identifies the extent to which the end of the outline 493 is tapered.
Feature extension, which affects the length or size of a part of the outline. For example, the feature 455 of the outline can be lengthened without affecting the rest of the outline. In another example, the vertical strokes of outline 495 can be lengthened or shortened. Additionally, the space between each vertical stroke of outline 495 can also be affected according to the value of an associated parameter.
Radius, which affects the size of an element's outline that has a circular shape. In some implementations, parameters can be used to specify major and minor radii for outlines that have an elliptical shape.

One or more of the above can also be combined into a single parameter. For example, one element can be associated with two parameters corresponding each to horizontal and vertical scale. Another element can be associated with a single parameter that affects both horizontal and vertical scale (e.g., proportional scaling of the outline). The combined transformation may be useful if the outline appears in multiple glyphs in varying, but proportional sizes.

In some implementations, each encoded element can include an encoding of the element's outline (e.g., specified as a series of lines and curves). Each element can also include information that specifies how many transformational parameters the element has, which transformations are associated with those parameters, and which points in the element are associated with each transformation. For example, information can be encoded with the element associated with outline 448 indicating which points of the outline are subject to a curvature transformation.

In some implementations, the value specified for an element's parameter in the glyph can be relative to a previously specified glyph. For example, the position of outline 490B can be specified relative to the element specified before it (e.g., outline 490A), rather than being specified relative to the glyph's origin 407). The value 435 associated with the vertical position of the outline 490B indicates the outline's position above the previous outline 490A. Likewise, the values 425 and 415 indicate the relative horizontal and vertical position of outline 490A relative to the position of outline 490B.

In some implementations, each individual value can be specified as a relative offset compared to a previously specified value. For example, an element reference may include the following six values: 610, 548, 457, 528, 427, 481. These same values can be specified using relative offsets as follows: 610, −62, −91, 71, −101, 54. In particular, note that, the second value, 548, is given by adding 610 and −62, while the third value is given by adding 548 and −91. Note, that when encoded in binary, the former six values require more than one byte each, whereas the later six values can be easily encoded in only seven bytes. Alternatively, a series of values can be specified as a relative offset with respect to the first value in the series (e.g., each of the above values can be given as an offset relative to the first value, 610).

Each glyph is specified by an encoding that can include references to elements and the value for each parameter of each referenced element. Generally, each glyph encoding is part of the larger font encoding and is typically stored in a file on a storage device (e.g., stored in and accessible from read-only or read-write memory). In some implementations, the font encoding can include the library of elements and information about each element's parameters and associated transformations. In other implementations, the library of elements can be encoded separately from the font. Alternatively, the library of elements can be encoded such that some of the elements are encoded with the font and some of the elements are encoded separately from the font (e.g., a global library of elements that multiple font encodings can refer to).

In some implementations, a glyph can be encoded as a series of instructions that each have one or more operands. For example, an instruction can indicate that a line is to be drawn from the current position to a second position by specifying a ‘lineto’ instruction with two operations indicating the horizontal and vertical aspects of the second position. An instruction can also reference an element indicating that an element's outline is to be drawn from the library of elements; such an instruction can also specify a variable number of operands that can be interpreted as parameter values. For example, for a reference-instruction, the first operand can identify the particular element (e.g., referring to the element's position in the library of elements) while subsequent operands indicate the value of each of the element's parameters.

For example, a glyph that references the same element twice may have the following representative encoding:

84 34 −29 45 94 compose

39 −92 21 23 94 compose

In the above encoding ‘compose’ specifies an instruction that uses the first operand to identify a particular element, in this case the element ‘94’ in the library of elements. The remaining four operands are parameter values for the specified element. The rendered glyph would include two outlines both referring to the same element, but differing in position and shape according to these specified parameters.

In some implementations, the operands specifying the parameters of the element can be stacked, as in the following representative encoding:

84 34 −29 45 94 39 −92 21 33 94 compose

The first eight values specify the same four parameters for both of the two references given above. By stacking parameter values, the element ‘94’ is referred to for each multiple of four parameters specified in the encoding. In general, the parameters of an element can be stacked in this fashion so that for a given element that has n parameters, if m by n parameters are provided, m outlines are produced according to each m set of n parameters.

In addition to referring to elements, the glyph encoding can also include information that directly specifies an outline (e.g., as lines and curves, without referring to an element). Such information can be encoded with a glyph when necessary aspects of the glyph cannot be constructed alone, or constructed efficiently, from the elements available in the element library.

In some implementations, each encoded value, or number, can be encoded using a variable byte encoding. A variable byte encoding encodes a number in a variable number of bytes in proportion to the absolute value of the number. In some implementations, a single byte can be used to encode both small numbers as well as information specifying whether additional bytes are necessary to decode the number. For example, assuming v is the value of a first byte, then if v has a value between 32 and 246, then the encoded number is: v minus 139. If v has a value between 247 and 250 inclusive, then the encoded number is: (v−247)×256+v′+108, where v′ is the value of the byte following v. Similarly, if v has a value between 251 and 254 inclusive, then the encoded number is: (v−251)×(−256)−v′−108. If the value of v is 255, the number is encoded as a four byte signed number in the four bytes that follow v. The values of v between zero and 32 can be used to encode at least 32 unique instructions or operations (e.g., such as an instruction referencing an element in a library of elements, or an instruction to draw a line between a current position and the position given by an operand).

In some implementations, the glyph can be encoded to minimize the absolute value of each number used in the encoding. Rather than specifying the value of an outline in dimensions that require large values (e.g., a square box 300 by 300), the values can be minimized while still preserving the relative shape of the outline (e.g., a square box 30 by 30). Minimizing the absolute value of the numbers used to encode the glyph minimizes the number of bytes required to store the font; particularly if combined with one of the techniques discussed above, such as variable byte encoding or relative offsets.

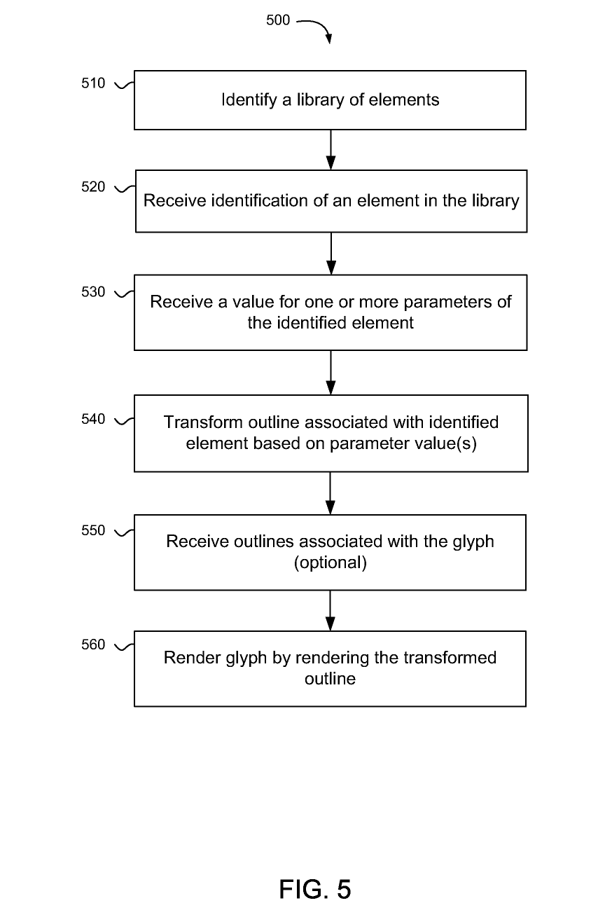

FIG. 5 is a flow diagram of a process 500 for rendering a glyph that includes references to the elements in a library of elements. The process 500 includes identifying a library of elements (step 510). In some implementations, a library of elements is included with a font that contains glyphs which refer to elements from the library. In other implementations, a library of elements can be identified separately from the font. The library of elements can be pre-defined (e.g., by an operating system, an application or a user preference). For example, a library of elements can be identified from which multiple separate fonts (e.g., where each font has a different style or includes different sets of glyphs) can each refer to the same library of elements.

Process 500 includes receiving an identification of an element in the library of elements (step 520). A glyph in a font can identify, in a reference, a particular element in the library of elements. Process 500 includes receiving a value for one or more parameters of the identified element (step 530). The values for each parameter are associated to, or encoded with, each reference to the element in the glyph. Receiving a value can include decoding a value that has been encoded to minimize the space required to specify the value. For example, a value can be specified as a relative offset from a previous value, or the value can be encoded in a compact variable-byte encoding and/or the parameters of multiple references to the same element can be stacked. The value of each transformational parameter is used to determine the shape of the outline associated with the element when the outline is rendered.

Process 500 includes transforming the outline associated with the identified element based on the values of each parameter, as specified in the glyph's element reference (step 540). The transformation of each glyph is based on the element as specified in the library of elements (e.g., the parameters that are associated with the element), and the particular outline associated with the element. In general, a glyph can identify several elements in multiple references and, for each reference, specify parameter values for each element of each reference. For each reference the outline of the referenced element is transformed (e.g., steps 520 through 540 can be repeated for each reference in the glyph).

Process 500 can optionally include receiving additional outlines associated with the glyph (step 550). Such outlines are not associated with any element in the library of elements. A glyph can include such outlines, specified as a lines and curves, particularly if the glyph depicts a shape that cannot be specified efficiently as one or a combination of multiple elements in the library.

Process 500 includes rendering the glyph by rendering the transformed outline (step 560). The transformed outline is rendered in a similar fashion as rendering an outline as though it had been specified as a part of the glyph. In general, this involves rasterizing the outline and may include other operations such as anti-aliasing, sub-pixel rendering. In some implementations, the glyph can be rendered directly to a display device. In other implementations, a rendering or the transformed outlines of each glyph is stored in a memory cache (e.g., a portion of memory, typically high-speed, volatile memory). When rendering the glyphs to a display device, the glyphs can be rendered or copied from the cache. Rendering the glyph to a display device from a cache minimizes the decoding, outline transformation, and rasterization necessary to render a series of glyphs, which can often include multiple renderings of the same glyph.

Generally, a transformed outline is rendered for each reference in the glyph. Among implementations where one or more outlines are also specified with the glyph (e.g., as received in step 550), the glyph specific outlines are also rendered.

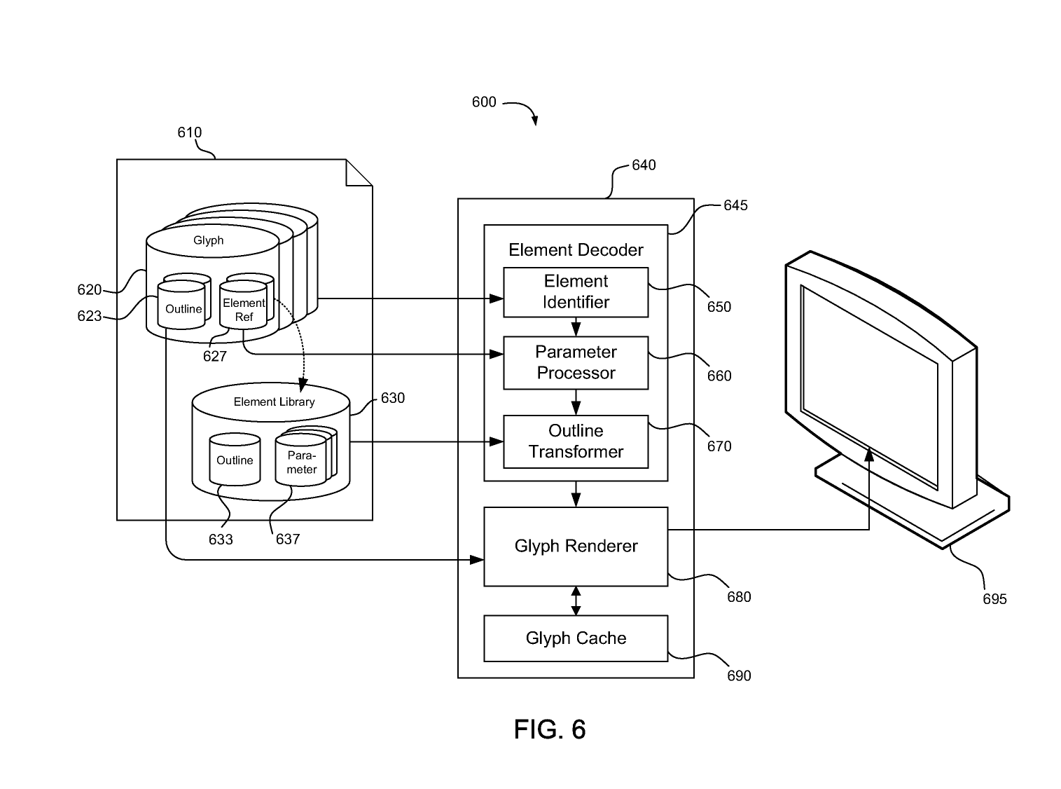

FIG. 6 illustrates a system 600 for rendering glyphs that refer to elements in a library of elements. The system 600 generally includes modules (e.g., module 650-690) and resources (e.g., font information 610). A module is typically a unit of distinct functionality that can provide and receive information to and from other modules. Modules can facilitate communication with input or output devices (e.g., glyph renderer 680). Modules can operate on resources. Generally, a resource is a collection of information that is operated on by a module. In some implementations, however, a module that provides information to another module can behave like a resource and vice-versa. For example, the glyph cache 690 can, in some implementations, be considered a resource.

The system 600 includes font information 610, which includes information relating to one or more fonts, where each font includes glyph information 620 for one or more glyphs. The glyph information for each glyph can include one or more outlines 623 and one or more references 627 to an element. Each reference in the glyph identifies an element in the library of elements 630. The library of elements 630 includes one or more elements that each include an outline 633 and both positional and transformational parameters 637.

The system 600 includes a font rendering engine 640. The font rendering engine 630 includes an element decoder 645 for decoding received glyph information 620. The element decoder 645 includes an element identifier 650 for decoding the glyph element references 627 that identify elements in the element library 630. For example, the element identifier 650 can identify element-reference instructions and the instructions' respective operands, which can specify both the referenced element and values for the element's respective parameters. The glyph information relating to the value of an element's parameters can be decoded by a parameter processor 660. The parameter processor 660 can determine how many parameters the referenced element requires. In some implementations the parameter processor 660 can determine when parameters have been stacked (e.g., multiple references to the same element encoded as multiple sets of parameters without explicitly re-identifying the referenced element).

The element decoder 645 can also include an outline transformer 670, which transforms the outline associated with an element based on the value of the parameters specified in the glyph and processed by the parameter processor 660. The outline transformer 645 can perform operations that adjust points in the outline relative to one another. For example, points can be moved horizontally or vertically apart (e.g., corresponding to horizontal and vertical scaling parameters).

The font rendering engine 640 can also include a glyph renderer 680. The glyph renderer 680 can render the glyph using the transformed outlines of elements referenced in the glyph, and any outlines specified with the glyph itself, if any. The glyph renderer can render each glyph directly to a display device 695. The display device 695 can include a CRT or LCD monitor, a projection display device, or a built-in display device such as those found on a hand-held or portable communications, entertainment or control device.

In some implementations, the glyph renderer 680 can render glyphs into a glyph cache. Glyphs can be rendered into the glyph cache 690 on demand (e.g., as needed) or can be pre-rendered into the glyph cache 690 (e.g., when the font is loaded by the system). In such implementations, when rendering to a display device 695, the glyph renderer 680 can render glyphs by accessing a pre-rendered glyph in the glyph cache 690 rather than rendering the glyph from scratch.

In general, modules and resources illustrated in the system 600 can be combined or divided and implemented in some combination of hardware or software on one or more computing devices connected by one or more networks.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine readable storage device, a machine readable storage substrate, a memory device, a composition of matter effecting a machine readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results.

What is claimed is:

1. A computer-implemented method comprising:
identifying a library of elements, each element in the library of elements associated with an outline and one or more parameters;
identifying a glyph having one or more references to a respective element in the library of elements, each reference specifying a value for one or more of the parameters associated with the respective element; and
rendering the glyph based on each respective element referenced by the glyph, the value of the one or more parameters specified by each reference affecting the appearance of the rendered element.

2. The method of claim 1, where each element in the library of elements is distinct from all other elements in the library of elements.

3. The method of claim 1, where rendering the glyph further comprises:
rendering each outline associated with each respective element referenced by the glyph based on the value of the associated one or more parameters, the value of each of one or more parameters affecting a shape of the outline.

4. The method of claim 1, where each of the one or more parameters associated with an element describes transformations of the associated outline, each transformation affecting the shape of the outline when rendered, including one or more of the outline's height, width, rotation, thickness, taper, extension, radius, and curvature.

5. The method of claim 4, where:
each transformation affects the shape of a portion of the outline.

6. A computer-implemented method comprising:
encoding a library of elements, each element in the library of elements associated with an outline and with one or more parameters, each element in the library of elements being distinct from all other elements in the library; and
encoding a glyph based on a plurality of references to respective elements in the library of elements, each reference having a value for one or more of the associated one or more parameters.

7. The method of claim 6, where:
each of one or more parameters are associated to a transformation of the element's associated outline.

8. The method of claim 7, where transformations affect the shape of the outline and include one or more of the following:
height, width, rotation, thickness, taper, extension, radius, and curvature.

9. The method of claim 8, where:
each transformation affects the shape of a portion of the outline.

10. The method of claim 6, where:
the value of parameters in the reference are encoded using offsets relative to the value of a previously encoded reference.

11. The method of claim 6, where encoding the glyph includes:
determining the smallest absolute value of each parameter.

12. The method of claim 6, where encoding a glyph includes:
encoding a plurality of references that refer to a particular element by specifying values for the parameters of the particular element for each of the plurality of references and identifying the particular element only once.

13. The method of claim 6, where encoding a glyph includes:
encoding values using variable byte encoding.

14. A computer readable media comprising a data structure for storing a glyph, the data structure comprising:
one or more references to an element in a library of elements, each element in the library of elements associated with an outline; and
a plurality of values for each of the one or more references, the one or more values describing the shape of the outline associated with the respective element of the one or more references.

15. A computer program product, encoded on a computer-readable medium, operable to cause data processing apparatus to perform operations comprising:
identifying a library of elements, each element in the library of elements associated with an outline and one or more parameters;
identifying a glyph having one or more references to a respective element in the library of elements, each reference specifying a value for one or more of the parameters associated with the respective element; and
rendering the glyph based on each respective element referenced by the glyph, the value of the one or more parameters specified by each reference affecting the appearance of the rendered element.

16. The product of claim 15, where rendering the glyph further comprises:
rendering each outline associated with each respective element referenced by the glyph based on the value of the associated one or more parameters, the value of each of one or more parameters affecting a shape of the outline.

17. A computer program product, encoded on a computer-readable medium, operable to cause data processing apparatus to perform operations comprising:
encoding a library of elements, each element in the library of elements associated with an outline and with one or more parameters, each element in the library of elements being distinct from all other elements in the library; and
encoding a glyph based on a plurality of references to respective elements in the library of elements, each reference having a value for one or more of the associated one or more parameters.

18. The product of claim 17, where rendering the glyph further comprises:
rendering each outline associated with each respective element referenced by the glyph based on the value of the associated one or more parameters, the value of each of one or more parameters affecting a shape of the outline.

19. A system comprising:
a means for identifying a library of elements, each element in the library of elements associated with an outline and one or more parameters;
a means for identifying a glyph having one or more references to a respective element in the library of elements, each reference specifying a value for one or more of the parameters associated with the respective element; and
a means for rendering the glyph based on each respective element referenced by the glyph, the value of the one or more parameters specified by each reference affecting the appearance of the rendered element.

20. A system comprising:
a means for encoding a library of elements, each element in the library of elements associated with an outline and with one or more parameters, each element in the library of elements being distinct from all other elements in the library; and
a means for encoding a glyph based on a plurality of references to respective elements in the library of elements, each reference having a value for one or more of the associated one or more parameters.
